(19) United States
(12) Patent Application Publication
(10) Pub. No.: US 2014/0004248 A1
(43) Pub. Date: Jan. 2, 2014

(54) Processes of Purifying Steviol Glycosides

(71) Applicants: Yong Luke Zhang, Burnaby (CA); Cunbiao Kevin Li, Burnaby (CA)

(72) Inventors: Yong Luke Zhang, Burnaby (CA); Cunbiao Kevin Li, Burnaby (CA)

(73) Assignee: GLG Life Tech Corporation, Vancouver, BC (CA)

(21) Appl. No.: 13/977,558

(22) PCT Filed: Dec. 30, 2011
(86) PCT No.: PCT/CA11/01428

§ 371 Date: Sep. 19, 2013

(30) Foreign Application Priority Data
Dec. 30, 2010 (CN) 201010613268.4
Dec. 30, 2010 (CN) 201010613270.1
Dec. 30, 2010 (CN) 201010613287.7

(51) Int. Cl. A23L 1/221

(52) U.S. Cl. CPC A23L 1/2215
USPC 426/658; 426/431

(57) ABSTRACT

A process for producing the natural sweetener composition which comprises at least one of steviolbioside (STB) extract, Rebaudioside B extract and Rebaudioside D extract (“collectively, the “extracts”) comprises the steps of preparing a mother liquor comprising a mass content of at least 20% of at least one of the extracts; preparing feed liquid comprising at least 20 mg/mL of mother liquor; flowing feed liquid through a porous adsorption column, having a pore size of at least 40 Angstroms, a pore volume of a least 0.8 mL/g and at a flow rate of at least 1L/min and at a pH of between 4 to 5; eluting at least one steviolbioside (STB) extract, Rebaudioside B extract and Rebaudioside D extract with alcohol having a mass concentration of at least 65%; fractionally collecting one or more eluates based on chromatographic critical points for each of the steviolbioside STB extract, the Rebaudioside B extract and the Rebaudioside D extract; concentrating the extracts at a temperature of between 60-80° C.; and drying the extracts so formed.

### FIELD OF THE INVENTION

The present invention relates generally to natural sweetener compositions comprising plant glycosides and methods for producing the same from Stevia rebaudiana.

### BACKGROUND

In the food and beverage industry, there is a general preference for the consumption of sweet foods, and manufacturers and consumers commonly add sugar in the form of sucrose (table sugar), fructose or glucose to beverages, food, etc. to increase the sweet quality of the beverage or food item. Although most consumers enjoy the taste of sugar, sucrose, fructose and glucose are high calorie sweeteners. Many alternatives to these high calorie sweeteners are artificial sweeteners or sugar substitutes, which can be added as an ingredient in various food items.

Common artificial sweeteners include saccharin, aspartame, and sucralose. Unfortunately, these artificial sweeteners have been associated with negative side effects. Therefore, alternative, natural non-caloric or low-caloric or reduced caloric sweeteners have been receiving increasing demand as alternatives to the artificial sweeteners and the high calorie sweeteners comprising sucrose, fructose and glucose. Like some of the artificial sweeteners, these alternatives provide a greater sweetening effect than comparable amounts of caloric sweeteners; thus, smaller amounts of these alternatives are required to achieve a sweetness comparable to that of sugar. These alternative, natural sweeteners, however, can be expensive to produce and/or possess taste characteristics different than sugar (such as sucrose), including, in some instances, undesirable taste characteristics such as sweetness linger, delayed sweetness onset, negative mouth feels and different taste profiles, such as off-tastes, including bitter, metallic, cooling, astringent, licorice-like tastes.

Steviol glycosides are responsible for the sweet taste of the leaves of the stevia plant (Stevia rebaudiana Bertoni). These compounds range in sweetness from 40 to 300 times sweeter than sucrose. They are heat-stable, pH-stable, and do not ferment.¹ They also do not induce aglycemic response when ingested, making them attractive as natural sweeteners to diabetics and others on carbohydrate-controlled diets.

The chemical structures of the diterpene glycosides of Stevia rebaudiana Bertoni are presented in FIG. 1. The physical and sensory properties are well studied generally only for Stevioside (STV) and Rebaudioside A. The sweetness potency of Stevioside is around 210 times higher than sucrose, Rebaudioside A in between 200 and 400 times, and Rebaudioside C and Dulcoside A around 30 times. Rebaudioside A is considered to have most favorable sensory attributes of the four major steviol glycosides (see Table 1):

TABLE 1

| | | | | Optical | | | |
|---|---|---|---|---|---|---|---|
| | | | | rotation | | | |
| | | | | [α]²⁵D | | | |
| | | T_{M} [symbol] | Mol. | (H₂O, | Solubility | Relative | Quality of |
| Name | Formula | [symbol] C. | Weight | 1%. w/v) | in water, % | sweetness | taste |
| Steviol | C₂₀H₃₀O₃ | 212-213 | 318.45 | ND | ND | ND | Very bitter |
| Steviolmonoside | C₂₆H₄₀O₈ | ND | 480.58 | ND | ND | ND | ND |
| Stevioside | C₃₈H₆₀O₁₈ | 196-198 | 804.88 | −39.3 | 0.13 | 210 | Bitter |
| Rebaudioside A | C₄₄H₇₀O₂₃ | 242-244 | 967.01 | −20.8 | 0.80 | 200-400 | Less Bitter |
| Rebaudioside B | C₃₈H₆₀O₁₈ | 193-195 | 804.88 | −45.4 | 0.10 | 150 | Bitter |
| Rebaudioside C | C₄₄H₇₀O₂₂ | 215-217 | 951.01 | −29.9 | 0.21 | 30 | Bitter |
| Rebaudioside D | C₅₀H₈₀O₂₈ | 248-249 | 1129.15 | −29.5 | 1.00 | 220 | Like sucrose |
| | | | | (ethanol) | | | |
| Rebaudioside E | C₄₄H₇₀O₂₃ | 205-207 | 967.01 | −34.2 | 1.70 | 170 | Like sucrose |
| Rebaudioside F | C₄₃H₆₈O₂₇ | ND | 936.99 | −25.5 | | ND | |
| | | | | (methanol) | | | |
| Dulcoside A | C₃₈H₆₀O₁₇ | 193-195 | 788.87 | −50.2 | 0.58 | 30 | Very bitter |
| Steviolbioside | C₃₂H₅₀O₁₃ | 188-192 | 642.73 | −34.5 | 0.03 | 90 | Unpleasant |
| Rubusoside | C₃₂H₅₀O₁₃ | ND | 642.73 | 642.73 | ND | 110 | Very bitter |

[symbol]

indicates data missing or illegible when filed

Stevia rebaudiana, after extraction and refinement is extensively used in the fields of foods, beverages, alcoholic liquor preparation, medicines, cosmetics, etc. In recent years, Stevia rebaudiana glycosides as extracts of Stevia rebaudiana have been used even more popularly as natural sweeteners and attractive alternatives to artificial sweeteners. They have become an excellent sweetening option since their caloric value is extremely low and they do not cause adverse effects to dental patients and diabetic patients. The potential market is huge.

Stevia rebaudiana glycosides mainly comprise the following nine components: Stevioside (STV), rebaudioside A (RA), rubusoside, dulcoside A (DA), rebaudioside C (RC), rebaudioside F (RF), rebaudioside D (RD), steviolbioside (STB), and rebaudioside B (RB).

The diterpene known as steviol is the aglycone of stevia's sweet glycosides, which are constructed by replacing steviol's carboxyl hydrogen atom with glucose to form an ester, and replacing the hydroxyl hydrogen with combinations of glucose and rhamnose to form an ether. The two primary compounds, stevioside and rebaudioside A, use only glucose: Stevioside has two linked glucose molecules at the hydroxyl site, whereas rebaudioside A has three, with the middle glucose of the triplet connected to the central steviol structure.

In terms of weight fraction, the four major steviol glycosides found in the stevia plant tissue are:
5-10% stevioside (STV) (250-300× of sugar)
2-12% rebaudioside A (RA)—most sweet (350-450× of sugar) and least bitter
1-2% rebaudioside C (RC)
½-1% dulcoside A. (DA)

Rebaudioside B, D, E and steviolbioside (STB) are known to be present in minute quantities;

The tastes of these components are different from one another and can meet the demands of different consumer populations, for example, the consumers in the United States of America and Canada are fond of RA, whereas the consumers in Japan and Korea are fond of STV.

Currently, the marketed Stevia rebaudiana glycoside products are mainly RA and STV, and there are still no products mainly containing RD and/or RB, therefore, the methods for extracting Stevia rebaudiana glycoside also mainly focus on the purification and refinement of RA and STV: there is still no good purification method for the selective extraction of RD and RB or in fact for very selective extraction and purification of individual glycosides RB, RD and steviolbioside (STB). Therefore, it would be highly beneficial to allow for such selective extraction to adapt to the diverse demands of consumers.

A process for the general recovery of diterpene glycosides, including stevioside from the Stevia rebaudiana plant is described (U.S. Pat. No. 4,361,697). A variety of solvents, having different polarities, were used in a sequential treatment that concluded with a high performance liquid chromatographic (HPLC) separation procedure.

The method for the recovery of RA from the leaves of Stevia rebaudiana plants is provided in U.S. Pat. No. 4,082,858. Final purification is achieved by liquid chromatography subsequent followed by an initial extraction with water an alkanol having from 1 to 3 carbon carbons, preferably methanol. It is also disclosed that water may be used as the initial solvent, although the preferred solvent at this stage is a liquid haloalkane having from 1 to 4 carbon atoms. The preferred second solvent is an alkanol having from 1 to 3 carbon atoms, while the preferred third solvent is an alkanol having from 1 to 4 carbon atoms and optionally minor amounts of water.

U.S. Pat. No. 4,892,938, to Giovanetto discloses a purification process in which the aqueous extracts of the plant are purified by passing these aqueous extracts through a series of ion-exchange resins which are selected to remove various impurities. The sweet glycosides remain in the water and are recovered by evaporation of the water. The advantage is that everything is done in water, while most other processes involve the use of a solvent at some point. The disadvantage is that the final product is quite impure with only about 70% is a mixture of the sweet glycosides. The balance is mainly material more polar than the sweet glycosides which we have identified as a complex mixture of polysaccharides (about 25%), and a small amount of yellow, oily material less polar than the sweet glycosides (about 5%).

The sweet glycosides obtained from Giovanetto process are always a mixture: namely the two principle sweet glycosides Stevioside and Rebaudioside A, and the two minor sweet glycosides Dulcoside and Rebaudioside C.

It is generally accepted that Stevioside has an aftertaste which is undesirable. This aftertaste is present in Stevioside samples of even greater than 99% purity. On the other hand, RA does not possess an aftertaste and has a sweetness flavour comparable to sucrose. Thus it is recognized as having the most desirable sensory properties. In addition to this complexity, various impurities are also present and some of these possess undesirable flavors. The entire matter is further clouded by the extreme difficulty of doing analyses.

The combined use of microfiltration, ultrafiltration, and nanofiltration is also applied for the purification of stevia extract (U.S. Pat. No. 5,972,120). The method, while satisfactory in some respects, is very expensive and as such commercially impractical. In addition, there remains the drawback of only isolating a mixture of glycosides, not pure individual compounds, such as stevioside and RA.

It is an object of the present invention to obviate or mitigate the above disadvantages.

### SUMMARY OF THE INVENTION

The present invention provides processes of selectively purifying one or more of RB, RD and steviolbioside (STB) from steviol glycoside compositions, compositions of such purified one or more of RB, RD and steviolbioside (STB) and uses thereof.

The present invention further provides a process of purifying one or more of RB, RD and steviolbioside (STB) from a stevia leaf extract and provides further optional downstream refining steps.

The present invention provides a process for producing the natural sweetener composition comprising at least one of steviolbioside (STB) extract, Rebaudioside B extract and Rebaudioside D extract (“collectively, the “extracts”), said process comprising the steps of:
a) preparing a mother liquor comprising a mass content of at least 20% of at least one of the extracts;
b) prepare feed liquid comprising at least 20 mg/mL of mother liquor;
c) flow feed liquid through a porous adsorption column, having a pore size of at least 40 Angstroms, a pore volume of a least 0.8 mL/g and at a flow rate of at least 1 L/min and at a pH of between 4 to 9;
d) eluting at least one extract, steviolbioside (STB), Rebaudioside B extract and Rebaudioside D extract with alcohol having a mass concentration of at least 65%;
e) fractionally collecting one or more eluates based on chromatographic critical points for each of the steviolbioside (STB) extract, the Rebaudioside B extract and the Rebaudioside D extract;
f) concentrating the extracts at a temperature of between 60-80° C.; and
g) drying the extracts so formed.

In another aspect, the present invention provides a process for purifying rebaudioside B, which comprises: preparing a mother liquor into a feed liquid of 20-25 mg/ml; allowing the feed liquid to flow through a macroporous adsorption resin column at a rate of 2.0-3.0 L/min with the average pore size of said macroporous adsorption resin column being from 50-60 A, with the pore volume thereof being 0.8-0.9 ml/g, and the pH thereof during the adsorption being in the range of 4.0-5.0; and after substantially complete adsorption, eluting the Stevia rebaudiana glycoside adsorbed on the resin column by using ethanol with a mass concentration of 70%-75%, collecting fractionally the eluates, concentrating the eluates at a temperature of 60° C.-80° C., and separately drying the resulting solid and liquid to give a crude rebaudioside B Stevia rebaudiana glycoside.

In another aspect, the present invention provides a process for purifying rebaudioside D, characterized by preparing a mother liquor into a feed liquid of 25-30 mg/ml, allowing the feed liquid to flow through a macroporous adsorption resin column at a rate of 2.5-4.0 L/min, wherein the average pore size of said resin column is 40-50 A, with a pore volume thereof being 0.9-1.0 ml/g, and the pH thereof during the adsorption being in the range of 4.5-5.5; and after substantially complete adsorption, eluting the Stevia rebaudiana glycoside adsorbed on the resin column by using ethanol with a mass concentration of 75%-80%; collecting fractionally the eluates, determining the critical points, then collecting the eluates at the critical points, concentrating at a temperature of 60° C.-80° C., and separately drying the resulting solid and liquid to give a crude Stevia rebaudiana glycoside.

In yet another aspect, the present invention provides a process for purifying steviolbioside (STB), characterized by preparing a mother liquor of solution into a feed liquid of 25-30 mg/mL, allowing the feed liquid to flow through a macroporous adsorption resin column in a rate of 1.0-2.0 L/min, wherein the average pore size of said resin column is 40-50 A, with a pore volume thereof being 0.9-1.0 mL/g, and the pH thereof during the adsorption being in the range of 4.0-5.0; and after substantially complete adsorption, eluting the Stevia rebaudiana glycosides adsorbed on the resin column by using ethanol with a mass concentration of 67%-72%; collecting fractionally the eluates, determining the critical points, then collecting the eluates at the critical points, concentrating at a temperature of 60° C.-80° C., and separately drying the resulting solid and liquid to give a crude Stevia rebaudiana glycoside.

The crude preparation step described above takes advantage of the selective adsorption of individual components of the Stevia rebaudiana glycoside mixture by a macroporous adsorption resin column according to differences in parameters such as polarity, molecular weight and molecular size and the like so as to enrich RB. Therefore, the polarity of the macroporous adsorption resin column affects the enrichment of RB to the greatest extent; then, the concentration of the feed liquid also has a significant effect on the adsorption capacity of the macroporous adsorption resin column, with either too low a concentration or too high a concentration reducing the adsorption capacity of the macroporous adsorption resin column; the average pore size and the pore volume of the resin column also affect, to some extent, the separation of individual components of Stevia rebaudiana glycoside and impurities; and the pH of the feed liquid has also a significant effect on the adsorption capacity of the resin column. In the elution step after complete adsorption, the mass concentration of ethanol directly affects the content of rebaudioside B in the Stevia rebaudiana glycoside mixture of the eluates, since the physical and chemical properties of the individual components are similar to one another, therefore, variation in the mass concentration of ethanol will change the composition of the eluted components and affect the content of rebaudioside B in the eluates. If the eluates are to be fractionally collected, the leakage points of the eluates can be determined by liquid phase chromatographic analysis, and then the eluates are collected. The similar macropore resin chromatography method and theory are used to enrich steviolbioside (STB) and RD.

The present invention further provides a natural sweetener composition comprising RB as prepared and isolated by the steps herein. The present invention further provides a natural sweetener composition comprising RD as prepared and isolated by the steps herein. The present invention further provides a natural sweetener composition comprising STB as prepared and isolated by the steps herein

The present invention further provides foods, beverages, nutraceuticals, functional foods, medicinal formulations, cosmetics, health products, condiments and seasonings comprising one or more of RB, RD and STB as prepared and isolated by the steps herein

These and other objects and advantages of the present invention will become more apparent to those skilled in the art upon reviewing the description of the preferred embodiments of the invention, in conjunction with the figures and examples. A person skilled in the art will realize that other embodiments of the invention are possible and that the details of the invention can be modified in a number of respects, all without departing from the inventive concept. Thus, the following drawings, descriptions and examples are to be regarded as illustrative in nature and not restrictive.

### BRIEF DESCRIPTION OF THE DRAWINGS

Embodiments of the present invention will now be described, by way of example only, with reference to the attached Figures, wherein:

FIG. 1 illustrates the chemical structures of RB, RD and STB; and

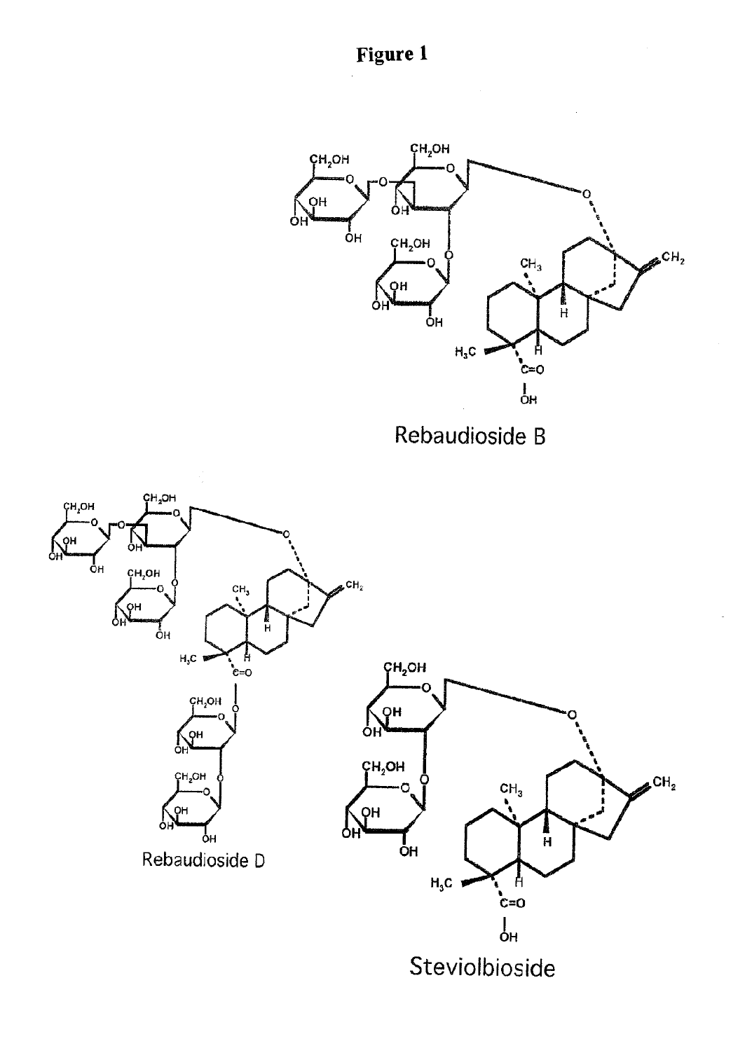

FIG. 2 is a flow diagram of the extraction process for extracting a primary extract of steviol glycosides from the leaves of Stevia rebaudiana to yield a mother liquor;

### DETAILED DESCRIPTION OF THE INVENTION

A detailed description of one or more embodiments of the invention is provided below along with accompanying figures that illustrate the principles of the invention. As such this detailed description illustrates the invention by way of example and not by way of limitation. The description will clearly enable one skilled in the art to make and use the invention, and describes several embodiments, adaptations, variations and alternatives and uses of the invention, including what we presently believe is the best mode for carrying out the invention. It is to be clearly understood that routine variations and adaptations can be made to the invention as described, and such variations and adaptations squarely fall within the spirit and scope of the invention.

In other words, the invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

In the present disclosure and claims (if any), the word “comprising” and its derivatives including “comprises” and “comprise” include each of the stated integers or elements but does not exclude the inclusion of one or more further integers or elements. The term process may be used interchangeably with method, as referring to the steps of purification described and claimed herein. The term rebaudioside B may be used interchangeably with RB (or Reb B), the term rebaudioside D may be used interchangeably with RD (or Reb D) and the term steviolbioside may be used interchangeably with STB. As used herein, the term “mother liquor of sugar” or “mother liquor” in the purification processes refers to a Stevia rebaudiana glycoside solution containing with respect to at least one of RB, RD and STB: a mass content of 20-30%, which can be prepared from the extract of Stevia rebaudiana or other Stevia rebaudiana glycoside products.

For clarity, it is to be noted that “steviol glycosides” have been referred to as stevia, stevioside, and stevia glycoside in the scientific literature. Generally, the term, steviol glycosides has been adopted for the family of steviol derivatives with sweetness properties that are derived from the stevia plant. More recently, the term, stevia, is used more narrowly to describe the plant or crude extracts of the plant, while stevioside is the common name for one of the specific glycosides that is extracted from stevia leaves. Stevioside is distinct from steviolbioside. As used herein, the term “about” in connection with a measured quantity, refers to the normal variations in that measured quantity, as expected by a skilled artisan making the measurement and exercising a level of care commensurate with the objective of measurement.

Within the scope of the invention, the mother liquor which provides a high content level of RB, RD and steviolbioside (STB) is prepared from the crystallization of stevia primary extract (SPE). With the purification process as described herein (which is the crystallization of stevia extract) RA, STV and RC, the concentration of RB, RD and steviolbioside (STB) in the mother liquor are enriched. The mother liquor, as preferably used herein, is a by-product from Reb A, Reb C and STV purification (crystallization and recrystallization) process. Accordingly, after purifying out (by these known techniques) the major components (such as RA, RC and STV), the percentage of minor components (such as RD, RB and STB) will be increased. In other words, the mother liquor which is the starting material of the present invention processing is a usually discarded by-product of conventional stevia leaf processing.

Natural sweetener compositions that have a taste profile comparable to sugar are desired. Further, a composition that is not prohibitively expensive to produce is preferred. Such a composition can be added, for example, to beverages and food products to satisfy consumers looking for a sweet taste. There is provided herein a process to selectively extract particular steviol glycosides in order to customize sweetening goals

The genus Stevia consists of about 240 species of plants native to South America, Central America, and Mexico, with several species found as far north as Arizona, New Mexico, and Texas. They were first researched by Spanish botanist and physician Petrus Jacobus Stevus (Pedro Jaime Esteve), from whose surname originates the Latinized word stevia.

Steviol glycosides have highly effective sweet taste properties. In fact, these compounds range in sweetness up to 380 times sweeter than sucrose. They are safe, non-toxic heat-stable, pH-stable, and do not ferment making them very commercially workable in the manufacture of foods and beverages. Furthermore, they do not induce a glycemic response when ingested (they have zero calories, zero carbohydrates and a zero glycemic index), making them extremely attractive as natural sweeteners to diabetics, those on carbohydrate-controlled diets and to anyone seeking healthy alternatives. The glycemic index, or GI, measures how fast a food will raise blood glucose level. Choosing foods that produce zero fluctuations in blood glucose is an important component for long-term health and reducing risk of heart disease and diabetes. As such, use of the natural sweetener compositions of the present invention has enormous advantages over cane, beet and other sugars.

During the extraction process, as increasing levels of purity of RB, RD, steviolbioside (STB) extracts are produced, the costs associated with achieving such increasing levels of purity also increases. Those skilled in the art will understand that purifying steviol glycoside extracts, including RB, RD and STB extracts, to higher levels of purity, especially purity levels greater than 95%, can be very costly, which can be limiting on the use of these steviol glycosides in sweetener compositions. This is the problem addressed herein.

Typically, steviol glycosides are obtained by extracting leaves of Stevia rebaudiana Bertoni with hot water or alcohols (ethanol or methanol); the obtained extract is a dark particulate solution containing all the active principles plus leaf pigments, soluble polysaccharides, and other impurities. Some processes remove the “grease” from the leaves with solvents such as chloroform or hexane before extraction occurs. There are dozens of extraction patents for the isolation of steviol glycosides, such processes often being categorized the extraction patents into those based on solvent, solvent plus a decolorizing agent, adsorption and column chromatography, ion exchange resin, and selective precipitation of individual glycosides. Methods using ultrafiltration, metallic ions, supercritical fluid extraction with CO, and extract clarification with zeolite are found within the body of more recent patents.

At the 68th Joint Expert Committee on Food Additives (“JECFA”) meeting in 2007, steviol glycosides were defined as the products obtained from the leaves of Stevia rebaudiana Bertoni. As cited by JECFA, the typical manufacture starts with extracting leaves with hot water and the aqueous extract is passed through an adsorption resin to trap and concentrate the component steviol glycosides. The resin is washed with methanol to release the glycosides and the product is recrystallized with methanol. Ion-exchange resins may be used in the purification process. The final product is commonly spray-dried. Table 2 (at the conclusion of the disclosure) provides a product monograph of steviol glycosides, including chemical names, structures, methods of assay and sample chromatogram showing elution times of nine major glycosides.

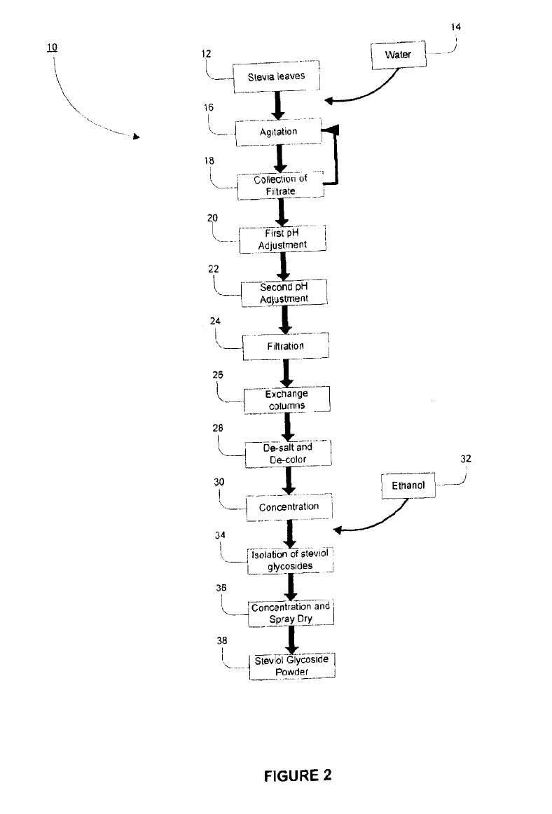

The following provides preferred steps of an extraction process used to isolate glycoside extracts (yielding mother liquor) from Stevia leaves. As shown in FIG. 2, the Reb A and STV extracts are isolated using the following steps. The Stevia leaves (12) are dried and the dried stevia leaves are agitated (16) in a volume of water (14) to release the sweet glycosides from the dried stevia leaves. Preferably, the sweet glycosides are released from the dried leaves using between about 1 volume to about 15 volumes of water. Even more preferably, the sweet glycosides are released from the dried leaves using about 12 volumes of water. The water-leaves mixture is agitated (16) for a period of time between about 10 minutes and about 1 hour, more preferably for a period of time between about 25 minutes and about 35 minutes. Following the agitation (16), the water-leaves mixture is drained and the filtrate collected (18). The cycle of agitation (16) and the collection of filtrate (18) is repeated for a total of about five cycles. Over the course of the five cycles, the water-leaves mixture is agitated for a total period of time between about 1 hour and about 5 hours, more preferably for a total period of time between about 2 hours and about 3 hours.

In one embodiment, for each agitation/collection cycle, the water-leaves mixture is agitated (16) in an environment having a temperature between about 5° C. and about 50° C., more preferably at a temperature between about 20° C. and about 30° C. Following the completion of the agitation/collection cycles, the pH of the water-leaves mixture is first adjusted to about pH 8.0 (20). The pH adjusted water/leaves mixture is then allowed to stand for a period of time between about 30 minutes and about two hours. The pH of the water-leaves mixture is then adjusted a second time (22) to about pH 7.0. The water-leaves mixture is subsequently filtered (24) to obtain an aqueous filtrate. The aqueous filtrate is then applied to ion exchange columns (26) to purify and decontaminate the aqueous filtrate. A person skilled in the art would understand that other methods may also be used to purify and decontaminate the aqueous filtrate. The aqueous filtrate is subsequently de-salted and de-colorized (28) and concentrated (30) using adsorption resin beds. A person skilled in the art would understand that other methods may also be used to concentrate the aqueous filtrate. A filtrate solution containing concentrated steviol glycosides is released from the adsorption resin beds (34) by rinsing the adsorption resin beds with ethanol (32), preferably about 70% ethanol (32).

### Reb B:

The present invention provides a Stevia rebaudiana glycoside prepared using the above-mentioned purification method (starting with the mother liquor) and in which the mass content of RB reaches about to 45%. Further concentration and purification steps (further refining) as also described herein, significantly increase concentration.

The method for purifying rebaudioside B mentioned above, in which the mass concentration of said ethanol is preferably 72%-75%.

The method for purifying rebaudioside B mentioned above, in which the surface property of said macroporous adsorption resin is non-polar.

The method for purifying rebaudioside B mentioned above, wherein the particle size of said macroporous adsorption resin column is preferably in the range of 16-60 mesh.

The method for purifying rebaudioside B mentioned above, in which the specific surface area of said macroporous adsorption resin column is preferably 1400-1600 m2/g; and this specific surface area is capable of adsorbing RB to the full extent.

The method for purifying rebaudioside B mentioned above, wherein the water content of said macroporous adsorption resin column is preferably about 60%-70%.

The method for purifying rebaudioside B mentioned above, wherein the bulk density of the macroporous adsorption resin column in the wet state is about 0.75-0.85 g/ml.

The method for purifying rebaudioside B mentioned above, in which the mass percentage of the solids after concentration is about 45%-50%.

The method for purifying rebaudioside B mentioned above, in which the volume of the resin column is preferably about 300-600 L.

The method for purifying rebaudioside B mentioned above, in which the crude rebaudioside B may also be subjected to a refining process, said refining process comprising the following steps:
preparing a mixed solvent by thoroughly mixing ethanol with a mass concentration of 80%±2% and 45%±2% methanol at a ratio of about 3:1, and heating it to 55-65° C.; placing said crude Stevia rebaudiana glycoside into the mixed solvent, with the mass ratio of the mixed solvent to said crude Stevia rebaudiana glycoside being about 2.0-2.5:1, allowing the crude Stevia rebaudiana glycoside to dissolve in the mixed solvent so as to form a liquid mixture, cooling down said liquid mixture to ambient temperature within about 4-7 minutes and then standing, during which the liquid mixture is stirred at intervals, standing for about 48-72 hours, performing a solid-liquid separation, and separately drying the resulting solid and liquid to obtain a refined Stevia rebaudiana glycoside.

In the above mentioned refining steps, since the polarities of individual components of Stevia rebaudiana glycoside (RB, RD and STB) are extremely similar to one another, the polarity of the solvent must be adjusted precisely, and a small difference in the polarity of the solvent will affect the solubility of individual components in the solvent, and for this reason the precise proportioning of the solvent is extremely critical, so that not only will the individual components and impurities thoroughly dissolve in the solvent, but also the solubility of the target product after being cooled down decreases most rapidly and it precipitates most rapidly; in addition, a precise dissolution temperature is not only advantageous for the thorough dissolution of the target product RB, but also advantageous for temperature control during an industrial process. Furthermore, the time for cooling during the cooling process also has a certain effect on the crystalline liquid, and either excessively rapid or excessively slow cooling is not advantageous for improving the purity of the target product after crystallization.

The method for purifying rebaudioside B mentioned above, the mixed solvent being cooled down to ambient temperature within about 5 minutes.

The method for purifying rebaudioside B mentioned above, the mixed solvent being preferably heated to about 57° C.-62° C.

The method for purifying rebaudioside B mentioned above, wherein the separate drying processes for the solid and liquid obtained from the solid-liquid separation comprise the following steps: adding non-saline water to dissolve the solid to give a solution with a mass concentration of 25%±2%, and then concentrating the solution to a concentration of 45%±2%, followed by drying the concentrated solution to give a product; evaporating off methanol, ethanol and superfluous water from the liquid, adjusting the mass concentration of the liquid to 45%±2%, and drying the solution to obtain a product.

The method for purifying rebaudioside B mentioned above, in which the solution is stirred every 4-6 hours for about 3-7 minutes each time during the standing period.

As compared with the prior art the present invention has the following advantages:
With the method for purifying rebaudioside B of the present invention, a Stevia rebaudiana glycoside product with an RB content higher than 45% can be obtained,
a Stevia rebaudiana glycoside product which mainly contains RB is provided, which meets the different demands of consumers

Regarding elution to remove each of the desired glycosides, HPLC (High Performance Liquid Chromatography) is preferably used to check the glycosides content in the eluate and to remove selected glycosides based on their known elution profiles.

### Reb D:

The present invention provides a Stevia rebaudiana glycoside prepared using the above-mentioned purification method (starting with the mother liquor) and in which the mass content of RD reaches about to 40%. Further concentration and purification steps (further refining) as also described herein, significantly increase concentration.

The method for purifying rebaudioside D mentioned above, in which the surface property of said macroporous adsorption resin is non-polar. The method for purifying rebaudioside D mentioned above, in which the mass concentration of said ethanol is preferably 75%-77%. The method for purifying rebaudioside D mentioned above, wherein the particle size of said macroporous adsorption resin column is in the range of 16-60 mesh. The method for purifying rebaudioside D mentioned above, in which the specific surface area of said macroporous adsorption resin column is preferably 1300-1400 m2/g; and this specific surface area is capable of adsorbing RD to the full extent. The method for purifying rebaudioside D mentioned above, wherein the water content of the macroporous adsorption resin column is preferably 65%-75%.

The method for purifying rebaudioside D mentioned above, wherein the bulk density of the macroporous adsorption resin column in the wet state is 0.65-0.70 g/ml. The method for purifying rebaudioside D mentioned above, in which the mass percentage of the solids after concentration is 45%-50%. The method for purifying rebaudioside D mentioned above, in which the volume of the resin column is preferably 300-500 L. The method for purifying rebaudioside D mentioned above, in which the crude rebaudioside D may also subjected to a further refining process, said refining process comprising the following steps:

preparing a mixed solvent by thoroughly mixing ethanol with a mass concentration of 88%±2% and 40% 2% methanol at a ratio of 3:2, and heating it to 65-75° C.; placing said crude Stevia rebaudiana glycoside into the mixed solvent, with the mass ratio of the mixed solvent to said crude Stevia rebaudiana glycoside being 3.0-3.5:1, allowing the crude Stevia rebaudiana glycoside to dissolve in the mixed solvent so as to form a liquid mixture cooling down said liquid mixture to ambient temperature within 4-7 mins and then standing, during which the liquid mixture is stirred at intervals, standing for 48-60 hours, performing a solid-liquid separation, and separately drying the resulting solid and liquid to obtain a refined Stevia rebaudiana glycoside.

In the above mentioned refining steps, since the polarities of individual components of Stevia rebaudiana glycoside are extremely similar to one another, the polarity of the solvent is preferably adjusted precisely, and a small difference in the polarity of the solvent will affect the solubility of individual components in the solvent, and for this reason the precise proportioning of the solvent is extremely critical, so that not only will the individual components and impurities thoroughly dissolve in the solvent, but also the solubility of the target product after being cooled down decreases most rapidly and it precipitates most rapidly; in addition, a precise dissolution temperature is not only advantageous for the thorough dissolution of the target product RD, but also advantageous for temperature control during an industrial process. Furthermore, the time for cooling during the cooling process also has a certain effect on the crystalline liquid, and either excessively rapid or excessively slow cooling is not advantageous for improving the purity of the target product after crystallization.

The method for purifying rebaudioside D mentioned above, the mixed solvent being cooled down to ambient temperature within 5 mins. The method for purifying rebaudioside D mentioned above, the mixed solvent being preferably heated to 67° C.-72° C. The method for purifying rebaudioside D mentioned above, wherein the separate drying processes for the solid and liquid obtained from the solid-liquid separation comprise the following steps: adding non-saline water to dissolve the solid to give a solution with a mass concentration of 25%±2%, and then concentrating the solution to a concentration of 45%±2%, followed by drying the concentrated solution to give a product; evaporating off methanol, ethanol and superfluous water from the solution, adjusting the mass concentration of the liquid to 45%±2%, and drying the solution to obtain a product. The method for purifying rebaudioside D mentioned above, in which the solution is stirred every 4-6 hours for 3-7 mins each time during the standing period.

As compared with the prior art the present invention has the following advantages: With the method for purifying rebaudioside D of the present invention, a Stevia rebaudiana glycoside product with a RD content higher than 40% can be obtained, and a Stevia rebaudiana glycoside product which mainly contains RD is provided, which meets the different demands of consumers.

Regarding elution to remove each of the desired glycosides, HPLC (High Performance Liquid Chromatography) is preferably used to check the glycosides content in the eluate and to remove selected glycosides based on their known elution profiles.

### Steviolbioside (STB)

The present invention provides a Stevia rebaudiana glycoside prepared using the above-mentioned purification method (starting with the mother liquor) and in which the mass content of RB reaches about to 40%. Further concentration and purification steps (further refining) as also described herein, significantly increase concentration.

The method for purifying steviolbioside (STB) mentioned above, in which the surface property of said macroporous adsorption resin is non-polar. The method for purifying steviolbioside (STB) mentioned above, in which the mass concentration of said ethanol is preferably 75%-77%.

The method for purifying steviolbioside (STB) mentioned above, wherein the particle size of said macroporous adsorption resin column is in the range of 16-60 mesh. The method for purifying steviolbioside (STB) mentioned above, in which the specific surface area of said macroporous adsorption resin column is preferably 1300-1400 m²/g; and this specific surface area is capable of adsorbing STB to the full extent. The method for purifying steviolbioside (STB) mentioned above, wherein the water content of the macroporous adsorption resin column is preferably 65%-75%. The method for purifying steviolbioside (STB) mentioned above, wherein the bulk density of the macroporous adsorption resin column in the wet state is 0.65-0.70 g/mL. The method for purifying steviolbioside (STB) mentioned above, in which the mass percentage of the solids after concentration is about 45%-50%. The method for purifying steviolbioside (STB) mentioned above, in which the volume of the resin column is preferably about 300-500 L.

The method for purifying steviolbioside (STB) mentioned above, in which the crude steviolbioside (STB) is also subjected to an optional additional refining process, said refining process comprising the following steps
preparing a mixed solvent by thoroughly mixing ethanol with a mass concentration of 90%±2% and 35%±2% methanol at a ratio of 1:3, and heating it to 65-75° C.; placing said crude Stevia rebaudiana glycoside into the mixed solvent, with the mass ratio of the mixed solvent to said crude Stevia rebaudiana glycoside being 3.0-3.5:2, allowing the crude Stevia rebaudiana glycoside to dissolve in the mixed solvent so as to form a mixed solution, cooling down said mixed solution to ambient temperature within 4-7 mins time and then standing, during which the mixed solution is stirred at intervals, standing for 48-60 hours, performing a solid-liquid separation, and separately drying the resulting solid and liquid to obtain a refined Stevia rebaudiana glycoside.

In the above mentioned refining steps, since the polarities of individual components of Stevia rebaudiana glycoside are extremely similar to one another, the polarity of the solvent should preferably be adjusted precisely, and the small differences in the polarity of the solvents will affect the solubility of individual components in the solvents, and for this reason the precise proportioning of the solvent is extremely critical, so that not only will the individual components and impurities to thoroughly dissolve in the solvent, but also the solubility of the target product after being cooled down decreases most rapidly and it precipitates most rapidly; in addition, dissolution temperature is not only advantageous for the thorough dissolution of the target product STB, but also advantageous for temperature control during an industrial process. Furthermore, the time for cooling during the cooling process also has a certain effect on the crystalline liquid, and either excessively rapid or excessively slow cooling is not advantageous for improving the purity of the target product after crystallization.

The method for purifying steviolbioside (STB) mentioned above, the mixed solvent being cooled down to normal temperature within 5 mins. The method for purifying steviolbioside (STB) mentioned above, the mixed solvent being preferably heated to 67° C.-72° C.

The method for purifying steviolbioside (STB) mentioned above, wherein the separate drying processes for the solid and liquid obtained from the solid-liquid separation comprise the following steps: adding non-saline water to dissolve the solid to give a solution with a mass concentration of 25%±2%, and then concentrating the solution to a′ concentration of 45%±2%, followed by drying the concentrated solution to give a product; evaporating off methanol, ethanol and superfluous water from the solution, adjusting the mass concentration of the liquid to 45%±2%, and drying the solution to obtain a product. The method for purifying steviolbioside (STB) mentioned above, in which the solution is stirred every 4-6 hours for 3-7 mins each time during the standing period.

As compared with the prior art the present invention has the following advantages: with the method for purifying steviolbioside (STB) of the present invention, a Stevia rebaudiana glycoside product STB with a content higher than 40% can be obtained, and a Stevia rebaudiana glycoside product which mainly contains STV is provided, which meets the different demands of consumers.

Regarding elution to remove each of the desired glycosides, HPLC (High Performance Liquid Chromatography) is preferably used to check the glycosides content in the eluate and to remove selected glycosides based on their known elution profiles.

The sweetener compositions of the present invention (comprising one or more glycosides prepared by the processes described herein) may be used in the preparation of various food products, beverages, medicinal formulations, chemical industrial products, among others. Exemplary applications/uses for the sweetener compositions include, but are not limited to: (a) food products, including canned food, preserved fruits, pre-prepared foods, soups, (b) beverages, including coffee, cocoa, juice, carbonated drinks, sour milk beverages, yogurt beverages, meal replacement beverages, and alcoholic drinks, such as brandy, whisky, vodka and wine; (c) grain-based goods—for example, bread and pastas, cookies, pastries, whether these goods are cooked, baked or otherwise processed; (d) fat-based products—such as margarines, spreads (dairy and non-dairy), peanut butter, peanut spreads, and mayonnaise; (d) Confectioneries—such as chocolate, candies, toffee, chewing gum, desserts, non-dairy toppings (for example Cool Whip®), sorbets, dairy and non-dairy shakes, icings and other fillings, (e) drug and medicinal formulations, particularly in coatings and flavourings; (f) cosmetics and health applications, such as for sweetening toothpaste; and (g) seasonings for various food products, such as soy sauce, soy sauce powder, soy paste, soy paste powder, catsup, marinade, steak sauce, dressings, mayonnaise, vinegar, powdered vinegar, frozen-desserts, meat products, fish-meat products, potato salad, bottled and canned foods, fruit and vegetables.

The natural sweetener compositions of the present invention may be formulated into premixes and sachets. Such premixes may then be added to a wide variety of foods, beverages and nutraceuticals. The purified natural sweetener compositions may, in one preferred form, be table top sweeteners.

In an alternative embodiment, the sweetener compositions of the present invention (comprising one or more glycosides prepared by the processes described herein) additionally comprise a secondary sweetening component. The secondary sweetening component is preferably selected from the group consisting of sucrose, erythritol, fructose, glucose, maltose, lactose, corn syrup (preferably high fructose), xylitol, sorbitol, or other sugar alcohols, inulin, miraculin, monetin, thaumatin and combinations thereof, and also non-natural sweeteners such as aspartame, neotame, saccharin, sucralose and combinations thereof. Preferably, for a 50% reduced calorie table top product, the ratio of a secondary sweetening component (most preferably sucrose) to the blends is preferably about 24.7:1. Such a natural sweetener composition can easily be added to food products and beverages, or can be used as a table top sweetener. The ratio of secondary sweetening component to the blends is more preferably between about 5:1 and 1:1. The natural sweetener compositions may be used alone or in combination with other secondary sweeteners, as described herein, and/or with one or more organic and amino acids, flavours and/or coloring agents.

While the forms of processes and compositions described herein constitute preferred embodiments of this invention, it is to be understood that the invention is not limited to these precise forms. As will be apparent to those skilled in the art, the various embodiments described above can be combined to provide further embodiments. Aspects of the present composition, method and process (including specific components thereof) can be modified, if necessary, to best employ the systems, methods, nodes and components and concepts of the invention. These aspects are considered fully within the scope of the invention as claimed. For example, the various methods described above may omit some acts, include other acts, and/or execute acts in a different order than set out in the illustrated embodiments.

Further, in the methods taught herein, the various acts may be performed in a different order than that illustrated and described. Additionally, the methods can omit some acts, and/or employ additional acts.

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

The following examples illustrate preferred embodiments of the present invention.

### EXAMPLES

### Example 1

### Extraction of Steviol Glycosides from Stevia rebaudiana Leaves-Preparation of Mother Liquor

One kg of the stevia leaves known to have a high content of Rebaudioside A were steeped with 2 kg of room temperature water having a pH of 7.3 in an agitation centrifuge. The leaves were agitated for 0.5 hour. The sweet water was filtered, the filtrate collected and the process repeated for a total of 5 steep/separation cycles. The pH of the sweet water filtrate solution was adjusted to pH 8.0 with approximately 30 grams of calcium hydroxide. After a rest time of about 1 hour, 50 grams of FeCl₃ was added to the sweet water filtrate solution to further adjust the pH to 7.0. The solution was filtered and the resulting filtrate had a transmittance of about 68±2% at 325 nm. The filtrate flows through the resin bed, and the glycosides was eluted from the resin bed by using 75% of ethanol. The eluate was concentrated to 45-50% of solid content, and then was vacuum dried. This dried eluate is called stevia extract or Stevia Primary Extract (SPE).

The mother liquor which content high level of RB, RD and steviolbioside (STB) is prepared from the crystallization of stevia primary extract (SPE). With the purification process (which is the crystallization of stevia extract) of RA, STV and RC, the concentration of RB, RD and steviolbioside (STB) in the mother liquor is enriched.

### Example 2

A mother liquor was taken, the RB content thereof was 27.12% as shown by the liquid phase chromatographic analysis, the mother liquor was prepared into a feed liquid with a concentration of 20 mg/ml, and the feed liquid was allowed to slowly flow through a 600 L DA-201-E resin column produced by Jiangsu Suqing Water Treatment Engineering Group at a flow rate of 2.0 L/min; the resin column selectively adsorbed the feed liquid according to the polarity of the individual components of Stevia rebaudiana glycoside as the feed liquid flowed through the resin column, the pH of the adsorption environment was 5.0, the feed liquid adsorption was completed after 15 hours, and Stevia rebaudiana glycoside adsorbed on the resin was desorbed by using 1600 L of 75% ethanol. The eluates were taken fractionally with 100 L as a unit, the RB contents were detected using liquid phase chromatographic analysis, it was found that a large amount of rebaudioside B was eluted out when the collected eluates reached the range of 800-900 L, and the parameters for the content of individual components of Stevia rebaudiana glycoside in the eluates after reaching 900 L relative to the content of the individual components in the feed liquid are shown in the following Table:

| Liquid phase | | | | |
|---|---|---|---|---|
| chromatographic | | | | RB content |
| analysis object | STV | RC | RB | improvement |
| Feed liquid | 12.51% | 4.88% | 27.12% | |
| 900 L | 16.40% | 4.07% | 42.40% | 15.63% |
| 1000 L | 18.59% | 4.91% | 41.42% | 14.65% |
| 1100 L | 11.74% | 16.24% | 42.91% | 16.14% |
| 1200 L | 13.07% | 16.49% | 43.83% | 17.06% |
| 1300 L | 11.69% | 15.81% | 40.42% | 13.65% |
| 1400 L | 14.47% | 17.03% | 42.20% | 15.43% |
| 1500 L | 13.73% | 16.07% | 40.59% | 13.82% |
| 1600 L | 17.35% | 18.40% | 44.45% | 17.68% |

It can be seen from the above table that the RB contents in all of the eluates were higher than 40%, the RB content in the eluate at the volume point of 1600 L even reached 44.45%, and the increase in RB content also reached 17.68% as compared with the RB content in the feed liquid. Therefore, preferably only the eluate at the volume point of 1600 L was taken during production, and the volume of the eluate was preferably equal to 2-2.5 times the volume of the resin column.

The eluate taken at the volume point of 1000 L was concentrated under the condition of 75° C., the solid content after concentration was controlled at 47%, the resulting solid and liquid were separately dried to give a crude Stevia rebaudiana glycoside, and the content of RB in the crude Stevia rebaudiana glycoside was measured as 50.16%.

The eluate taken at the volume point of 1200 L was concentrated under the condition of 70° C., the solid content after concentration was controlled at 48%, the resulting solid and liquid were separately dried to give a crude Stevia rebaudiana glycoside, and the content of RB in the crude Stevia rebaudiana glycoside was measured as 53.36%.

The eluate taken at the volume point of 1300 L was concentrated under the condition of 60° C., the solid content after concentration was controlled at 45%, the resulting solid and liquid were separately dried to give a crude Stevia rebaudiana glycoside, and the content of RB in the crude Stevia rebaudiana glycoside was measured as 45.63%.

The eluate taken at the volume point of 1600 L was concentrated under the condition of 80° C., the solid content after concentration was controlled at 50%, the resulting solid and liquid were separately dried to give a crude Stevia rebaudiana glycoside, and the content of RB in the crude Stevia rebaudiana glycoside was measured as 54.91%.

### Example 3

10 kg of crude Stevia rebaudiana glycoside prepared in example 2 with an RB content of 50.16% was taken and mixed with 22 kg of a mixed solvent prepared by mixing ethanol with a concentration of 78% and methanol of 43% in a proportion of 3:1, the resulting mixture was allowed to dissolve completely at 55° C. and rapidly cooled down to normal temperature within 5 mins, the mixture was stirred for 3 mins every 4 hours, it was left standing for 48 hours, the mixture after dissolution was subjected to solid-liquid separation, non-saline water was added to the solid which was filtered out to adjust its concentration to 27%, followed by concentrating to 43% and drying the solution to give 4 kg of refined Stevia rebaudiana glycoside.

The rebaudioside B content in the refined Stevia rebaudiana glycoside was 95.63%; and ethanol and the superfluous water were evaporated off from the liquid obtained by the solid-liquid separation, the concentration of the aqueous Stevia rebaudiana glycoside solution was adjusted to 47%, 4.5 kg of refined Stevia rebaudiana glycoside was obtained after drying, and the total recovery rate of Stevia rebaudiana glycoside was 85.2%.

### Example 4

10 kg of crude Stevia rebaudiana glycoside prepared in example 2 with an RB content of 54.91% was taken and mixed with 25 kg of a mixed solvent prepared by mixing ethanol with a concentration of 80% and methanol of 45% in a proportion of 3:1, the resulting mixture was allowed to dissolve completely at 57° C. and rapidly cooled down to normal temperature within 7 mins, the mixture was stirred for 5 mins every 5 hours, it was left standing for 60 hours, the mixture after dissolution was subjected to solid-liquid separation by using a plate-and-frame filter press, non-saline water was added to the solid which was filtered out to adjust its concentration to 25%, followed by concentrating to 45% and drying the solution to give 4 kg of refined Stevia rebaudiana glycoside. The rebaudioside B content in the refined Stevia rebaudiana glycoside was 95.34%; and ethanol and the superfluous water were evaporated off from the liquid obtained by the solid-liquid separation, the concentration of the aqueous Stevia rebaudiana glycoside solution was adjusted to 45%, 3.8 kg of refined Stevia rebaudiana glycoside was obtained after drying, and the total recovery rate of Stevia rebaudiana glycoside was 86.1%.

### Example 5

10 kg of Stevia rebaudiana glycoside powder with an RB content of 53.36% was taken and mixed with 20 kg of a mixed solvent prepared by mixing ethanol with a concentration of 82% and methanol of 47%, the resulting mixture was allowed to dissolve completely at 65° C. and rapidly cooled down to normal temperature within 4 mins, the mixture was stirred for 7 mins every 6 hours, it was left standing for 72 hours, the mixture after dissolution was subjected to solid-liquid separation by using a plate-and-frame filter press, non-saline water was added to the solid which was filtered out to adjust its concentration to 23%, followed by concentrating to 47% and drying the solution to give 5.4 kg of refined Stevia rebaudiana glycoside. The rebaudioside B content in the refined Stevia rebaudiana glycoside was 96.52%; and ethanol and the superfluous water were evaporated off from the liquid obtained by the solid-liquid separation, the concentration of the aqueous Stevia rebaudiana glycoside solution was adjusted to 45%, 3.7 kg of refined Stevia rebaudiana glycoside was obtained after drying, and the total recovery rate of Stevia rebaudiana glycoside was 89.3%.

It can be seen from the present examples described above that the RB content of Stevia rebaudiana glycoside can reach above 45% after crude preparation and can reach above 95% after the refining steps, and the recovery rate of Stevia rebaudiana glycoside was higher than 85%, and the purity thereof was very high.

The Stevia rebaudiana glycoside described above can be a powder or in crystalline form; the surrounding steam heating in the present invention denotes that a heating process is performed via steam which is introduced into a circular space formed by jacketing a big storage tank around a small storage tank; and the drying can be an existing drying means which is suitable for the present invention, for example, vacuum drying.

### Example 6

A mother liquor was taken, the RD content thereof was 25.66% as shown by the liquid phase chromatographic analysis, the mother liquor of sugar was prepared into a feed liquid with a concentration of 30 mg/ml, 1400 L of the feed liquid was taken, and the feed liquid was allowed to slowly flow through a 500 L DA-201-L resin column produced by Jiangsu Suqing Water Treatment Engineering Group at a flow rate of 2.5 L/min; the resin column selectively adsorbed the feed liquid according to the polarity of the individual components of Stevia rebaudiana glycoside as the feed liquid flowed through the resin column, the pH of the adsorption environment was 5.5, the feed liquid adsorption was completed after 15 hours, and Stevia rebaudiana glycoside adsorbed on the resin was desorbed by using 1400 L of 77% ethanol. The eluates were taken fractionally with 100 L as a unit, the RD contents were detected using liquid phase chromatographic analysis, it was found that a large amount of rebaudioside B was eluted out when the collected eluates reached 700 L, and the parameters for the content of individual main components of Stevia rebaudiana glycoside the eluates after reaching 700 L relative to the content of the feed liquid are shown in the following Table:

| | | | | | | total |
|---|---|---|---|---|---|---|
| Chromatographic | | | | RD | total | glycoside |
| analysis | | | | content | glycoside | content |
| object | STV | RC | RD | improvement | content | improvement |
| Feed | 22.43% | 14.85% | 25.66% | | 69.86% | |
| liquid | | | | | | |
| 700 L | 19.76% | 13.82% | 34.95% | 9.29% | 73.73% | 3.87% |
| 800 L | 20.53% | 14.89% | 33.42% | 7.76% | 74.36% | 4.50% |
| 900 L | 20.21% | 13.09% | 33.38% | 7.72% | 72.89% | 3.03% |
| 1000 L | 20.96% | 13.43% | 35.32% | 9.66% | 76.49% | 6.63% |
| 1100 L | 24.93% | 15.91% | 37.21% | 11.55% | 84.89% | 15.03% |
| 1200 L | 27.87% | 18.29% | 38.82% | 13.16% | 92.64% | 22.78% |
| 1300 L | 26.26% | 17.41% | 33.76% | 8.10% | 83.88% | 14.02% |
| 1400 L | 26.89% | 17.00% | 32.95% | 7.29% | 83.88% | 14.02% |

It can be seen from the above Table that the RD contents in all of the eluates were higher than 32%, the RD content in the eluate at the volume point of 1200 L even reached 38.82%, the increase in RD content also reached 13.16% as compared with the RD content in the feed liquid, and the total glycoside content increased by 22.78% as compared with the total glycoside content in the feed liquid. The RD content at both 1100 L and 1200 L increased by more than 10%, and the total glycoside content starting from 1100 L was increased by more than 14%, therefore the volume of the eluates was preferably equal to 2-2.4 times the volume of the resin column. The eluate at the volume point of 1200 L was selected because the RD content enrichment reached a maximal value at this volume.

The eluate taken at the volume point of 1000 L was concentrated under the condition of 75° C., the solid content after concentration was controlled at 47%, the resulting solid and liquid were separately dried to give a crude Stella rebaudiana glycoside, and the content of RD in the crude Stevia rebaudiana glycoside was measured as 43.16%.

The eluate taken at the volume point of 1200 L was concentrated under the condition of 70° C., the solid content after concentration was controlled at 48%, the resulting solid and liquid were separately dried to give a crude Stevia rebaudiana glycoside, and the content of RD in the crude Stevia rebaudiana glycoside was measured as 49.77%.

The eluate taken at the volume point of 1300 L was concentrated under the condition of 60° C., the solid content after concentration was controlled at 45%, the resulting solid and liquid were separately dried to give a crude Stevia rebaudiana glycoside, and the content of RD in the crude Stevia rebaudiana glycoside was measured as 42.63%.

The eluate taken at the volume point of 1400 L was concentrated under the condition of 80° C., the solid content after concentration was controlled at 50%, the resulting solid and liquid were separately dried to give a crude Stevia rebaudiana glycoside, and the content of RD in the crude Stevia rebaudiana glycoside was measured as 40.31%.

### Example 7

10 kg of crude Stevia rebaudiana glycoside prepared in example 6 with an RD content of 49.77° A was taken and mixed with 30 kg of a mixed solvent prepared by mixing ethanol with a concentration of 86% and methanol of 42% in a proportion of 3:2, the resulting mixture was allowed to dissolve completely at 65° C. and rapidly cooled down to normal temperature within 5 mins, the mixture was stirred for 3 mins every 4 hours, it was left standing for 48 hours, the mixture after dissolution was subjected to solid-liquid separation, non-saline water was added to the solid which was filtered out to adjust its concentration to 27%, followed by concentrating to 43% and drying the solution to give 3.2 kg of refined Stevia rebaudiana glycoside. The rebaudioside D content in the refined Stevia rebaudiana glycoside was 95.73%; and ethanol and the superfluous water were evaporated off from the liquid obtained by the solid-liquid separation, the concentration of the aqueous Stevia rebaudiana glycoside solution was adjusted to 47%, 5.6 kg of refined Stevia rebaudiana glycoside was obtained after drying, and the total recovery rate of Stevia rebaudiana glycoside was 88.0%.

### Example 8

10 kg of crude Stevia rebaudiana glycoside prepared in example 6 with an RD content of 49.77% was taken and mixed with 32 kg of a mixed solvent prepared by mixing ethanol with a concentration of 88% and methanol of 40% in a proportion of 3:2, the resulting mixture was allowed to dissolve completely at 67° C. and rapidly cooled down to normal temperature within 7 mins, the mixture was stirred for 5 mins every 5 hours, it was left standing for 60 hours, the mixture after dissolution was subjected to solid-liquid separation by using a plate-and-frame filter press, non-saline water was added to the solid which was filtered out to adjust its concentration to 25%, followed by concentrating to 45% and drying the solution to give 2.8 kg of refined Stevia rebaudiana glycoside. The rebaudioside D content in the refined Stevia rebaudiana glycoside was 95.34%; and ethanol and the superfluous water were evaporated off from the liquid obtained by the solid-liquid separation, the concentration of the aqueous Stevia rebaudiana glycoside solution was adjusted to 45%, 5.7 kg of refined Stevia rebaudiana glycoside was obtained after drying, and the total recovery rate of Stevia rebaudiana glycoside was 85.0%.

### Example 9

10 kg of Stevia rebaudiana glycoside powder with an RD content of 49.77% was taken and mixed with 35 kg of a mixed solvent prepared by mixing ethanol with a concentration of 90% and methanol of 38%, the resulting mixture was allowed to dissolve completely at 75° C. and rapidly cooled down to normal temperature within 4 mins, the mixture was stirred for 7 mins every 6 hours, it was left standing for 72 hours, the mixture after dissolution was subjected to solid-liquid separation by using a plate-and-frame filter press, non-saline water was added to the solid which was filtered out to adjust its concentration to 23%, followed by concentrating to 47% and drying the solution to give 3.5 kg of refined Stevia rebaudiana glycoside. The rebaudioside D content in the refined Stevia rebaudiana glycoside was 96.52%; and ethanol and the superfluous water were evaporated off from the liquid obtained by the solid-liquid separation, the concentration of the aqueous Stevia rebaudiana glycoside solution was adjusted to 45%, 5.5 kg of refined Stevia rebaudiana glycoside was obtained after drying, and the total recovery rate of Stevia rebaudiana glycoside was 90%.

It can be seen from the embodiments described above that the RD content of Stevia rebaudiana glycoside can reach above 40% after crude preparation and can reach above 95% after the refining steps, and the recovery rate of Stevia rebaudiana glycoside was higher than 85%, and the purity thereof was very high.

The Stevia rebaudiana glycoside described above can be a powder or in crystalline form; the surrounding steam heating in the present invention denotes that a heating process is performed via steam which is introduced into a circular space formed by jacketing a big storage tank around a small storage tank; and the drying can be an existing drying means which is suitable for the present invention, for example, vacuum drying.

### Example 10

A mother liquor was taken, the STB content thereof was 23.74% as shown by the liquid phase chromatographic analysis, the mother liquor of sugar was prepared into a feed liquid with a concentration of 30 mg/mL, 1400 L of the feed liquid was taken, and the feed liquid was allowed to slowly flow through a 500 L DA-201-L resin column produced by Jiangsu Suqing Water Treatment Engineering Group at a flow rate of 1.5 L/min; the resin column selectively adsorbed the feed liquid according to the polarities of the individual components of Stevia rebaudiana glycoside as the feed liquid flowed through the resin column, the pH of the adsorption environment was 5.5, the feed liquid adsorption was completed after 15 hours, and Stevia rebaudiana glycoside adsorbed on the resin was desorbed by using 1400 L of 70% ethanol. The eluates were taken fractionally with 100 L as a unit, the STB contents were detected using liquid phase chromatographic analysis, it was found that large amount of rebaudioside B was eluted out when the collected eluates reached 800 L, and the parameters with respect to the content of individual main components of Stevia rebaudiana glycosides after reaching 800 L relative to the content of the feed liquid were shown in the following Table:

| | | | | | | total | | mean value of |
|---|---|---|---|---|---|---|---|---|
| Chromatographic | | | | | total | glycoside | mean value of | glycoside |
| analysis | | | | STB content | glycoside | content | STB content | content |
| object | STV | RC | STB | improvement | content | improvement | improvement | improvement |
| Feed | 21.02% | 14.64% | 23.74% | | 66.25% | | | |
| liquid | | | | | | | | |
| 800 L | 21.72% | 14.71% | 36.92% | 13.18% | 77.05% | 10.80% | 12.05% | 8.22% |
| | 19.77% | 13.76% | 34.65% | 10.91% | 71.88% | 5.63% | | |
| 900 L | 23.25% | 15.49% | 35.88% | 12.14% | 78.92% | 12.67% | 11.16% | 9.67% |
| | 21.19% | 14.35% | 33.92% | 10.18% | 72.92% | 6.67% | | |
| 1000 L | 24.95% | 16.44% | 36.21% | 12.47% | 82.16% | 15.91% | 10.35% | 10.94% |
| | 21.82% | 14.33% | 31.96% | 8.22% | 72.22% | 5.97% | | |
| 1100 L | 25.40% | 16.48% | 32.28% | 8.54% | 79.11% | 12.86% | 9.67% | 16.06% |
| | 26.80% | 17.38% | 34.54% | 10.80% | 85.50% | 19.25% | | |
| 1200 L | 27.99% | 18.74% | 33.45% | 9.71% | 86.75% | 20.50% | 9.32% | 19.82% |
| | 27.90% | 18.22% | 32.66% | 8.92% | 85.39% | 19.14% | | |
| 1300 L | 26.96% | 18.02% | 31.31% | 7.57% | 83.16% | 16.91% | 6.99% | 15.42% |
| | 26.40% | 17.33% | 30.15% | 6.41% | 80.17% | 13.92% | | |
| 1400 L | 26.98% | 17.93% | 30.45% | 6.71% | 82.08% | 15.83% | 6.03% | 14.57% |
| | 25.69% | 17.55% | 29.09% | 5.35% | 79.56% | 13.31% | | |

It can be known from the above table that each fractional eluate as analyzed and tested and mean value was calculated. The STB contents in all of the eluates were higher than 31%, the STB content in the eluate at the volume point of 800 L even reached 36.92%, and the mean increase in the STB contents also reached 12.05% as compared with the STB content in the feed liquid. The mean content of STB for the points at 800 L and 1000 L increased more than 10%, therefore, the volume of the eluates was preferably equal to 1.5-2.0 times of the volume of the resin column. The eluate at the volume point of 800 L was selected because the STB content enrichment reached a maximal value at this volume.

The eluate taken at the volume point of 800 L was concentrated under the condition of 75° C., the solid content after concentration was controlled at 47%, the resulting solid and liquid were separately dried to give a crude Stevia rebaudiana glycoside, and the content of STB in the crude Stevia rebaudiana glycoside was measured as 48.86%.

The eluate taken at the volume point of 900 L was concentrated under the condition of 70° C., the solid content after concentration was controlled at 48%, the resulting solid and liquid were separately dried to give a crude Stevia rebaudiana glycoside, and the content of STB in the crude Stevia rebaudiana glycoside was measured as 44.77%.

The eluate taken at the volume point of 1000 L was concentrated under the condition of 60° C., the solid content after concentration was controlled at 45%, the resulting solid and liquid were separately dried to give a crude Stevia rebaudiana glycoside, and the content of STB in the crude Stevia rebaudiana glycoside was measured as 45.63%.

The eluate taken at the volume point of 1100 L was concentrated under the condition of 80° C., the solid content after concentration was controlled at 50%, the resulting solid and liquid were separately dried to give a crude Stevia rebaudiana glycoside, and the content of STB in the crude Stevia rebaudiana glycoside was measured as 42.31%.

### Example 11

20 kg of crude Stevia rebaudiana glycoside prepared in example 10 with an STB content of 48.86% was taken and mixed with a mixed solvent prepared by mixing 30 kg of ethanol with a concentration of 88% and methanol of 37% in a proportion of 1:3, the resulting mixture was allowed to dissolve completely at 65° C. and rapidly cooled down to normal temperature within 5 mins, the mixture was stirred for 3 mins every 4 hours, it was left standing for 48 hours, the mixture after dissolution was subjected to solid-liquid separation, non-saline water was added to the solid which was filtered out to adjust its concentration to 27%, followed by concentrating to 43% and drying the solution to give 6.2 kg of refined Stevia rebaudiana glycoside. The steviolbioside STB content in the refined Stevia rebaudiana glycoside was 95.73%; and ethanol and the superfluous water were evaporated off from the solution obtained by the solid-liquid separation, the concentration of the aqueous Stevia rebaudiana glycoside solution was adjusted to 47%, 11 kg of refined Stevia rebaudiana glycoside was obtained after drying, and the total recovery rate of Stevia rebaudiana glycoside was 86.0%.

### Example 12

20 kg of crude Stevia rebaudiana glycoside prepared in example 10 with an STB content of 48.86% was taken and mixed with a mixed solvent prepared by mixing 32 kg of ethanol with a concentration of 90% and methanol of 35% in a proportion of 1:3, the resulting mixture was allowed to dissolve completely at 67° C. and rapidly cooled down to normal temperature within 7 mins, the mixture was stirred for 5 mins every 5 hours, it was left standing for 60 hours, the mixture after dissolution was subjected to solid-liquid separation by using a plate-and-frame filter press, non-saline water was added to the solid which was filtered out to adjust its concentration to 25%, followed by concentrating to 45% and drying the solution to give 6.4 kg of refined Stevia rebaudiana glycoside. The steviolbioside STB content in the refined Stevia rebaudiana glycoside was 95.34%; and ethanol and the superfluous water were evaporated off from the solution obtained by the solid-liquid separation, the concentration of the aqueous Stevia rebaudiana glycoside solution was adjusted to 45%, 11.5 kg of refined Stevia rebaudiana glycoside was obtained after drying, and the total recovery rate of Stevia rebaudiana glycoside was 89.5%.

### Example 13

20 kg of Stevia rebaudiana glycoside powder with an STB content of 53.36% was taken and mixed with a mixed solvent prepared by mixing 35 kg of ethanol with a concentration of 92% and methanol of 33%, the resulting mixture was allowed to dissolve completely at 75° C. and rapidly cooled down to normal temperature within 4 mins, the mixture was stirred for 7 mins every 6 hours, it was left standing for 72 hours, the mixture after dissolution was subjected to solid-liquid separation by using a plate-and-frame filter press, non-saline water was added to the solid which was filtered out to adjust its concentration to 23%, followed by concentrating to 47% and drying the solution to give 7.1 kg of refined Stevia rebaudiana glycoside. The steviolbioside STB content in the refined Stevia rebaudiana glycoside was 96.52%; and ethanol and the superfluous water were evaporated off from the solution obtained by the solid-liquid separation, the concentration of the aqueous Stevia rebaudiana glycoside solution was adjusted to 45%, 11.0 kg of refined Stevia rebaudiana glycoside was obtained after drying, and the total recovery rate of Stevia rebaudiana glycoside was 90.5%.

It can be known from the embodiments described above that the STB content of Stevia rebaudiana glycoside can reach above 40% after crude preparation and can reach above 95% after the refining steps, and the recovery rate of Stevia rebaudiana glycoside was higher than 85%, and the purity thereof was very high.

The Stevia rebaudiana glycoside described above can be a powder or in crystalline form; the surrounding steam heating in the present invention denotes that a heating process is performed via steam which is introduced into a circular space formed by jacketing a big storage tank around a small storage tank; and the drying can be an existing drying means which is suitable for the present invention, for example, vacuum drying.

1. A process for producing the natural sweetener composition comprising at least one of steviolbioside (STB) extract, Rebaudioside B extract and Rebaudioside D extract (“collectively, the “extracts”), said process comprising the steps of:
a) preparing a mother liquor comprising a mass content of at least 20% of at least one of the extracts;
b) prepare feed liquid comprising at least 20 mg/mL of mother liquor;
c) flow feed liquid through a porous adsorption column, having a pore size of at least 40 Angstroms, a pore volume of a least 0.8 mL/g and at a flow rate of at least 1 L/min and at a pH of between 4 to 5;
d) eluting at least one steviolbioside (STB) extract, Rebaudioside B extract and Rebaudioside D extract with alcohol having a mass concentration of at least 65%;
e) fractionally collecting one or more eluates based on chromatographic critical points for each of the steviolbioside STB extract, the Rebaudioside B extract and the Rebaudioside D extract;
f) concentrating the extracts at a temperature of between 60-80° C.; and
g) drying the extracts so formed.

2. The process of claim 1 wherein the mother liquor is formed via the steps of
a) drying Stevia leaves;
b) mixing and agitating the dried Stevia leaves with water to produce a water-leaves mixture; and
c) filtering the water-leaves mixture to obtain an aqueous filtrate.

3. The process of claim 2 wherein the mixture and agitation of the dried Stevia leaves with water is conducted with about 1 volume of water to about 15 volumes of water.

4. The process of claim 2, wherein the mixture and agitation of the dried Stevia leaves with water is conducted for about one hour to about five hours at about 5° C. to about 50° C.

5. A process for purifying rebaudioside B, which comprises: preparing a mother liquor of into a feed liquid of 20-25 mg/ml; allowing the feed liquid to flow through a macroporous adsorption resin column at a rate of 2.0-3.0 L/min with the average pore size of said macroporous adsorption resin column being from 50-60 A, with the pore volume thereof being 0.8-0.9 ml/g, and the pH thereof during the adsorption being in the range of 4.0-5.0; and after substantially complete adsorption, eluting the Stevia rebaudiana glycoside adsorbed on the resin column by using ethanol with a mass concentration of 70%-75%, collecting fractionally the eluates, concentrating the eluates at a temperature of 60° C.-80° C., and separately drying the resulting solid and liquid to give a crude rebaudioside B Stevia rebaudiana glycoside.

6. The process for purifying rebaudioside B according to claim 5, characterized in that said crude Stevia rebaudiana glycoside is also subjected to a further refining process, said refining process comprising the following steps:
a) preparing a mixed solvent by thoroughly mixing ethanol with a mass concentration of 80%±2% and 45%±2% methanol at a ratio of 3:1, and heating the mixed solvent to 55-65° C.;
b) placing said crude Stevia rebaudiana glycoside into the mixed solvent, with the mass ratio of the mixed solvent to said crude Stevia rebaudiana glycoside being 2.0-2.5:1,
c) allowing the crude Stevia rebaudiana glycoside to dissolve in the mixed solvent so as to form a liquid mixture,
d) cooling down said liquid mixture to ambient temperature within 4-7 minutes;
e) letting said liquid mixture stand for 48-72 hours, while stirring at intervals;
f) performing a solid-liquid separation;
g) separately drying the resulting solid and liquid to obtain a refined rebaudioside B Stevia rebaudiana glycoside.

7. The process of claim 5, characterized in that the particle size of said macroporous
adsorption resin column is in the range of 16-60 meshes.

8. The process of claim 5, characterized in that the specific surface area of said macroporous adsorption resin column is 1400-1600 m2/g.

9. The process of claim 5, characterized in that the water content of said macroporous
adsorption resin column is 60%-70%.

10. The process of claim 5, characterized in that the bulk density of said macroporous adsorption resin column in the wet state is 0.75-0.85 g/ml.

11. The process of claim 5, characterized in that the mass percentage of the solids in the liquid mixture after concentration is 45%-50%.

12. The process of claim 6, characterized in that the separate drying processes of the solid and liquid resulting from the solid-liquid separation comprise the following steps: adding non-saline water to dissolve the solid to give a solution with a mass concentration of 25%±2%, and then concentrating the solution to a concentration of 45%+2%, followed by drying the concentrated solution to give a product; evaporating off methanol, ethanol and superfluous water from the liquid, adjusting the mass concentration of the liquid to 45%±2%, and drying the solution to obtain a product.

13. The process of claim 6, characterized by stirring every 4-6 hours for at least 3 minutes each time during the standing period.

14. The process of claim 5 wherein macroporous adsorption column is a styrene type co-polymer.

15. A composition comprising the rebaudioside B Stevia rebaudiana glycoside prepared according to the process of claim 5.

16. A process for purifying rebaudioside D, characterized by preparing a mother liquor of sugar into a feed liquid of 25-30 mg/ml, allowing the feed liquid to flow through a macroporous adsorption resin column at a rate of 2.5-4.0 L/min, wherein the average pore size of said resin column is 40-50 A, with a pore volume thereof being 0.9-1.0 ml/g, and the pH thereof during the adsorption being in the range of 4.5-5.5; and after substantially complete adsorption, eluting the Stevia rebaudiana glycoside adsorbed on the resin column by using ethanol with a mass concentration of 75%-80%; collecting fractionally the eluates, determining the critical points, then collecting the eluates at the critical points, concentrating at a temperature of 60° C.-80° C., and separately drying the resulting solid and liquid to give a crude Stevia rebaudiana glycoside.

17. The process of claim 16 wherein said crude Stevia rebaudiana glycoside is also subjected to a refining process, said refining process comprising the following steps: preparing a mixed solvent by thoroughly mixing ethanol with a mass concentration of 88%±2% and 40%+2% methanol at a ratio of 3:2, and heating it to 65-75° C.; placing said crude Stevia rebaudiana glycoside into the mixed solvent, with the mass ratio of the mixed solvent to said crude Stevia rebaudiana glycoside being 3.0-3.5:1, allowing the crude Stevia rebaudiana glycoside to dissolve in the mixed solvent so as to form a mixed solution, cooling down said mixed solution to ambient temperature within 4-7 mins and then standing, during which the mixed solution is stirred at intervals, standing for 48-60 hours, performing a solid-liquid separation, and separately drying the resulting solid and liquid to obtain a refined Stevia rebaudiana glycoside.

18. The process of claim 16, characterized in that the particle size of said macroporous adsorption resin column is in the range of 16-60 meshes.

19. The process of claim 16, characterized in that the specific surface area of said macroporous adsorption resin column is 1300-1400 m2/g.

20-22. (canceled)

23. The process of claim 17, characterized in that the separate drying processes of the solid and liquid resulted from the solid-liquid separation comprise the following steps: adding non-saline water to dissolve the solid to give a solution with a mass concentration of 25%±2%, and then concentrating the solution into a concentration of 45%+2%, followed by drying the concentrated solution to give a product; evaporating off methanol, ethanol and superfluous water from the liquid, adjusting the mass concentration of the liquid to 45% 2%, and drying the solution to obtain a product.

24-25. (canceled)

26. A composition comprising the rebaudioside D Stevia rebaudiana glycoside prepared according to the process of claim 16.

27. A process for purifying steviolbioside (STB), characterized by preparing a mother liquor of sugar into a feed liquid of 25-30 mg/mL, allowing the feed liquid to flow through a macroporous adsorption resin column in a rate of 1.0-2.0 L/min, wherein the average pore size of said resin column is 40-50 A, with a pore volume thereof being 0.9-1.0 mL/g, and the pH thereof during the adsorption being in the range of 4.0-5.0; and after substantially complete adsorption, eluting the Stevia rebaudiana glycosides adsorbed on the resin column by using ethanol with a mass concentration of 67%-72%; collecting fractionally the eluates, determining the critical points, then collecting the eluates at the critical points, concentrating at a temperature of 60° C.-80° C., and separately drying the resulting solid and liquid to give a crude Stevia rebaudiana glycoside.

28. The process of claim 27, characterized in that said crude Stevia rebaudiana glycoside is also subjected to a refining process, said refining process comprising the following steps preparing a mixed solvent by thoroughly mixing 90%±2% of ethanol and 35% 2% of methanol at a ratio of 1:3, and heating it to 65-75° C.; placing said crude Stevia rebaudiana glycoside into the mixed solvent, with a mass ratio of the mixed solvent to said crude Stevia rebaudiana glycoside being 3.0-3.5:2, allowing the crude Stevia rebaudiana glycoside to dissolve in the mixed solvent so as to form a mixed solution, cooling down said mixed solution to ambient temperature within 4-7 minutes and then standing, during which the mixed solution is stirred, standing for 48-60 hours, performing a solid-liquid separation, and separately drying the resulting solid and liquid to obtain a refined Stevia rebaudiana glycoside.

29-33. (canceled)

34. The process of claim 28, characterized in that the separately drying processes of the solid and liquid resulted from the solid-liquid separation comprise the following steps: adding non-saline water to dissolve the solid to give a solution with a mass concentration of 25% 2%, and then concentrating the solution into a concentration of 45%±2%, followed by drying the concentrated solution to give a product; evaporating off methanol, ethanol and superfluous water from the solution, adjusting the mass concentration of the solution to 45%+2%, and drying the solution to obtain a product.

35-36. (canceled)

37. A composition comprising the STB Stevia rebaudiana glycoside prepared according to the process of claim 27.

38. A composition comprising the rebaudioside B Stevia rebaudiana glycoside prepared according to the process of claim 6.
